(19) United States
(12) Patent Application Publication
(10) Pub. No.: US 2025/0146676 A1
(43) Pub. Date: May 8, 2025

(54) HEAT SUPPLY NETWORK FOR A PROCESS PLANT, AND METHOD FOR OPERATING SUCH A HEAT SUPPLY NETWORK

(71) Applicant: DÜRR SYSTEMS AG, Stuttgart (DE)

(72) Inventors: Alexander HAMMEN, Bönningheim (DE); Tobias JÄGER, Karlsruhe (DE); Martin HOPPE, Markgröningen (DE)

(21) Appl. No.: 18/730,186

(22) PCT Filed: Jan. 18, 2023
(86) PCT No.: PCT/DE2023/100035

§ 371 Date: Jul. 18, 2024

(30) Foreign Application Priority Data
Jan. 21, 2022 (DE) 10 2022 101 450.9

(51) Int. Cl. F24D 12/02; B05C 11/10; F25B 29/00; F25B 30/00; F25B 41/20

(52) U.S. Cl. CPC F24D 12/02; B05C 11/10; F25B 29/00; F25B 30/00; F25B 41/20; F24D 2200/12; F24D 2200/16; F24D 2200/32; F24D 2220/042; F24D 2220/046

(57) ABSTRACT

The invention relates to a thermal supply network (1000) for a process plant, in particular for a painting plant, comprising a fluid connection for supplying consumers (200, 220; 300, 302, 304, 306; 320, 322, 324) arranged therein with heat and/or cold via a heat transfer fluid in the fluid connection, in which at least two consumers (200, 300, 320; 220, 302, 304, 306, 322, 324) are connected fluidically in series, wherein the first consumer (200, 300, 320) is fluidically connected at least temporarily, by means of its first outlet (205, 305, 325) for the heat transfer fluid, to a second consumer (220, 302, 304, 306, 322, 324) via the second inlet (223) thereof.

### FIELD OF THE DISCLOSURE

The disclosure relates to a heat supply network for a process plant, in particular a painting plant, and to a method for operating such a heat supply network.

### BACKGROUND

Warm or hot water is usually used to supply painting plants with heat. Various processes, e.g. the pretreatment plant, intermediate dryers but also ventilation plants for process applications or even general ventilation, are thereby supplied with heat.

All the consumers are typically designed for the same temperature levels. Separate networks with different temperature levels are also known, as are networks with a variable inlet temperature. Warm water typically has temperatures of up to 60° C., the term “hot water” generally being used above this. In the case of hot water networks with a variable inlet temperature, it is assumed that the heating demand is greater in winter than in summer. Thus, the output is increased in winter. However, the increase in output applies to all the connected consumers and process steps.

The process step with the highest requirements on the supply of hot water in respect of the inlet and outlet temperatures determines the temperatures for all the other process steps in order to allow simple and efficient pipework for the consumers. Furthermore, this makes the required volume flow very large in some cases since the consumer with the highest temperature requirements determines the temperature spread for all the other consumers.

Other solutions, which are embodied with distributors, lead to complex pipework and an increased use of materials since there has to be individual piping from the distributor to each consumer. Other solutions, e.g. the use of multivalent reservoirs, can likewise lead to an increased expenditure on pipework.

In typical painting plants, e.g. those for painting vehicle bodies, process lines with lengths of several hundred meters are common, and therefore the pipework for the consumers is complex and expensive.

### SUMMARY

The object of examples disclosed herein is to provide an energy-efficient heat supply network for a process plant.

Another object of examples disclosed herein is to provide an advantageous method for operating such a heat supply network.

The objects are achieved by the features of the independent claims. Advantageous embodiments and advantages of examples disclosed herein will become apparent from the other claims, the description and the drawing.

The proposal is for a heat supply network for a process plant, in particular for a painting plant, comprising a fluid connection for supplying consumers arranged therein with heat and/or cold via a heat transfer fluid in the fluid connection, in which at least two consumers are connected fluidically in series, wherein the first consumer is fluidically connected at least temporarily, by means of its first outlet for the heat transfer fluid, to a second consumer via the second inlet thereof.

In the text which follows, the term “warm water” is used up to a water temperature of 65° C. in order to illustrate the difference with respect to hot water systems in the prior art.

Examples disclosed herein allow a reduction in the required volume flow in the supply of heat and/or cold to consumers by increasing the temperature spread. This leads to a considerable energy saving in the heat supply network.

Furthermore, the temperature level at the consumers can be lowered.

Thus, for example, in high-temperature regions of treatment baths in a painting plant, e.g. a degreasing bath, a power of about 12 MW is required to provide hot water at a temperature of 90° C. at the inlet, which leaves the consumer at 70° C. with a relatively high volume flow. At a temperature of 85° C. at the inlet and 55° C. at the outlet, the heat supply network requires a significantly lower volume flow with the same power.

A lower volume flow allows smaller pipe diameters and/or lower material costs and/or smaller pumps and/or lower electricity costs and/or a smaller space requirement and/or less assembly effort.

With lower temperature requirements, it is possible to open up previously unused waste heat sources within a painting plant.

It is likewise possible to incorporate alternative heat sources, e.g. heat pumps, without necessarily having to use high-temperature heat pumps. It is advantageously possible to use one or more heat pumps in order to connect a heating circuit and a cooling circuit. Savings of about 6 MWh/a are thus possible, for example, in a painting plant for painting vehicle bodies in northern latitudes, with a typical energy consumption of 500-600 kWh/body.

When using heat pumps, it is possible, in particular, to lower the temperature level of the heat sources.

An advantageous reduction in the fossil-based primary energy demand and the associated CO₂ emissions is possible.

The various processes, i.e. consumers, in the process plant, in particular painting plant, are interlinked hydraulically, i.e. fluidically, in such a way that they form a unit. In particular, the first consumer and the at least one second consumer form a temperature cascade as regards the heat transfer fluid. The hot water required for the first consumer is heated only to the temperature level that is required for the process with the highest process temperature. This process is, at the same time, also the first consumer. The subsequent second consumers or process steps receive the outlet of the preceding process step as an inlet. They are operated with warm water, i.e. at a lower temperature than the hot water which is fed to the first consumer. It is possible either for these subsequent consumers to be parallel to one another or for the cascade to be extended, depending on the requirements of the processes.

By means of corresponding sensors and actuators as well as an interface with the heat sources and with the process or consumers, the temperatures in the heat supply can be adapted to the respective operating situation and the heat demand. The consumers can be connected to one another in such a way that the warm water or hot water made available in the inlet is only as hot as necessary, and the temperature in the outlet is correspondingly low.

Ultimately, it is thereby possible to heat the hot water only to the extent necessary for the process with the highest requirements, and the other processes can be operated with warm water.

In order to exploit the advantages of hot or warm water networks with different temperature levels, waste heat sources that were not previously used, especially in painting plants, and possibly heat sources that were not usable in the prior art on account of the previously high temperature level, e.g. conventional heat pumps instead of high-temperature heat pumps, or condensing natural-gas boilers, can be employed.

These measures make it possible to integrate as yet unexploited waste heat sources in a painting plant at relatively low temperature levels, e.g. waste heat from compressed air generation, from cooling zones or alternative heat sources, which make available heat at a relatively low temperature level, in particular lower than 65° C., into the heat supply system of a painting plant with process heat and to make them a component part of the painting plant.

In known painting plants, for example, some or all of the waste heat from compressed air generation is not used by the processes in a painting plant. There is a considerable increase in the energy that can be recovered from heat sources that are already in use. Using the example of a dryer heating boiler which can provide a maximum power of 1200 kW in the case of warm water at 90° C. in the inlet and 60° C. in the outlet, this power increases to 1900 KW if the warm water is at 75° C. in the inlet and 30° C. in the outlet.

Moreover, the complexity of the piping can be reduced with hydraulic separators or distributors in comparison with the known solutions. The possible increase in the outlay on control can be adapted accordingly.

As an option, for example, the heat sources can be fed in in an appropriate manner according to their temperature levels. This has the advantage that only the partial flow for the respective consumer is increased to the required temperature, but lower temperature levels are also possible at other points, allowing the incorporation of heat sources with lower temperature levels.

It is not only the supply of heat that can be designed in the above-described manner of a temperature cascade between the first and the at least one second consumer. Cold water networks can likewise be cascaded. In this case, it is possible to supply cold to processes or consumers that can be operated with low cold water temperatures and processes or consumers that can be operated with higher cold water temperatures.

According to an advantageous embodiment of the heat supply network, at least one heat source having the highest temperature of the heat transfer fluid can be connected to the first inlet of the first consumer in order to supply heat. In particular, the first consumer and the at least one second consumer form a temperature cascade as regards the heat transfer fluid. The hot water required for the first consumer is heated only to the temperature level that is required for the process with the highest process temperature. This process is, at the same time, also the first consumer. The subsequent second consumers or process steps receive the outlet of the preceding process step as an inlet. They are operated with warm water, i.e. at a lower temperature than the hot water which is fed to the first consumer. It is possible either for these subsequent consumers to be parallel to one another or for the cascade to be extended, depending on the requirements of the processes.

According to an advantageous embodiment of the heat supply network, at least one heat source having the lowest temperature of the heat transfer fluid can be connected to the first inlet of the first consumer in order to supply cold. Cold water networks can advantageously be cascaded. In this case, it is possible to supply cold to processes or consumers that can be operated with low cold water temperatures and processes or consumers that can be operated with higher cold water temperatures.

According to an advantageous embodiment of the heat supply network, downstream of the first consumer in respect of the heat transfer fluid, a plurality of second consumers is connected fluidically in series and/or in parallel. The second consumers or process steps following the first consumer receive the outlet of the preceding process step. They can therefore be operated with warm water, i.e. at a lower temperature than the hot water which is fed to the first consumer. It is possible either for these subsequent consumers to be parallel to one another or for the cascade to be extended, depending on the requirements of the processes.

According to an advantageous embodiment of the heat supply network, at least one temperature sensor can be arranged in a section of the fluid connection between the first outlet of the first consumer and the second consumer. By means of corresponding sensors and actuators as well as an interface with the heat sources and with the process or consumers, the temperatures in the heat supply can be adapted to the respective operating situation and the heat demand of the consumers. The consumers can be connected to one another in such a way that the warm water or hot water made available in the inlet is only as hot as necessary, and the temperature in the outlet is correspondingly low.

According to an advantageous embodiment of the heat supply network, a pressure sensor can be arranged in a section of the fluid connection between the first outlet of the first consumer and the second consumer. For example, the pressure sensor can be arranged between the second inlet and the second outlet of the at least one second consumer. The pressure in the section of the fluid connection can indicate the consumption of heat transfer fluid in the at least second consumer.

According to an advantageous embodiment of the heat supply network, a bypass line for bypassing the first and/or the at least one second consumer can be arranged in the fluid connection. It is thereby possible to adapt the supply of heat and/or cold in the heat supply network to the current demand. Thus, individual consumers can be selectively connected up to or disconnected from the supply of heat transfer fluid in the cascade, e.g. in the case of maintenance work on consumers and the like.

According to an advantageous embodiment of the heat supply network, at least one control valve, which selectively opens or shuts off at least one of the consumers and/or at least one of the heat sources for the heat transfer fluid, can be arranged in the fluid connection. It is thereby possible to achieve a flow of heat transfer fluid to individual consumers in a manner appropriate to demand. Thus, individual consumers can be selectively connected up to or disconnected from the supply of heat transfer fluid in the cascade, e.g. in the case of maintenance work on consumers and the like.

According to an advantageous embodiment of the heat supply network, a plurality of heat sources can be arranged fluidically in series and/or in parallel in respect of the heat transfer fluid. Individual heat sources can be connected up or disconnected depending on their availability and/or on the demand from individual consumers.

According to an advantageous embodiment of the heat supply network, at least one heat source can be arranged fluidically in parallel with the at least one second consumer.

Thus, a first heat source can supply the first consumer or the inlet thereof with heat transfer fluid at a high temperature, and can receive the heat transfer fluid at a medium temperature from the outlet of the first consumer. A second heat source can supply the second consumer, the inlet of which is coupled to the outlet of the first consumer, with heat transfer fluid at a medium temperature and can receive heat transfer fluid at a low temperature from the outlet thereof. A further heat source can supply the inlet of the first consumer with heat transfer fluid at a high temperature, and can receive the heat transfer fluid at a low temperature from the outlet of the second consumer. It is advantageously possible respectively for the first heat source to selectively supply the first consumer and for the second heat source to selectively supply the second consumer with heat transfer fluid, or for the further heat exchanger to supply the first consumer in series with the second consumer. Depending on the operating conditions of the process plant and the available waste heat or demand for heat transfer fluid of the respective consumers, it is also possible for there to be a combination of heat sources to supply the consumers.

According to an advantageous embodiment of the heat supply network, at least one heat source can have at its outlet a three-way valve, the inlet of which is connected to at least one further heat source and the outlet of which is connected to the inlet of the first consumer. The heat sources can advantageously deliver heat transfer fluid at the same temperature level. In this way, it is possible to set a flow rate of heat transfer fluid which is fed to the first consumer.

According to an advantageous embodiment of the heat supply network, the first consumer and the at least one second consumer can be fluidically connected, by means of a respective inlet and a respective outlet, via at least one hydraulic separator, wherein the at least one hydraulic separator has at least two temperature zones with different temperature levels. In particular, there can be a fluidic connection between the at least one hydraulic separator and consumers and heat sources. The hydraulic separator may also be referred to as a multivalent reservoir. For example, the inlet of the first consumer can be fed with heat transfer fluid at a high temperature level from the hydraulic separator. The outlet of the first consumer can feed into a region of the hydraulic separator to which one or more second consumers are connected by their inlets and are connected in parallel with one another. The second consumer or consumers receive heat transfer fluid at the temperature level of the outlet of the first consumer, corresponding to a medium temperature level. The outlet of the second consumer or consumers can feed into a region of the hydraulic reservoir with the lowest temperature level. Heat sources can feed heat transfer fluid into various regions with different temperature levels. Likewise, heat transfer fluid can be taken from regions of the hydraulic separator which are at intermediate temperatures between the highest and the medium or the medium and the lowest temperature level.

According to an advantageous embodiment of the heat supply network, an inlet and an outlet for heat transfer fluid of the at least one hydraulic separator can be connected by means of an overflow line. In particular, an inlet to a region of the separator with a higher temperature of the heat transfer fluid can be connected to an outlet from a region of the separator with a lower temperature of the heat transfer fluid. The overflow line can have a controllable three-way valve. In this way it is advantageously possible to ensure operation in all operating states, e.g. when starting up the heat supply network or if the volume flows of the heat transfer fluid delivered by one or more heat sources at one temperature level and that consumed by one or more consumers at a different temperature level differ too widely and there is a risk of an unwanted change in the temperature zones in the separator.

According to an advantageous embodiment of the heat supply network, at least one heat pump and/or one cold generator can be arranged in the fluid connection.

It is likewise possible to incorporate alternative heat sources, e.g. heat pumps, without necessarily having to use high-temperature heat pumps. It is advantageously possible to use one or more heat pumps in order to connect a heating circuit and a cooling circuit. Savings of about 6 MWh/a are thus possible, for example, in a painting plant for painting vehicle bodies in northern latitudes, with a typical energy consumption of 500-600 kWh/body.

When using heat pumps, it is possible, in particular, to lower the temperature level of the heat sources.

According to an advantageous embodiment of the heat supply network, at least one of the heat sources is a waste heat source.

The advantages of hot or warm water networks with different temperature levels can be exploited, and waste heat sources that were not previously used, especially in painting plants, and possibly heat sources that were not usable in the prior art on account of the previously high temperature level, e.g. conventional heat pumps instead of high-temperature heat pumps, or condensing natural-gas boilers, can be employed.

It is likewise possible, for example, for the waste heat from the generation of compressed air to be used by the processes or consumers in the process plant, in particular painting plant. There is a considerable increase in the energy that can be recovered from heat sources that are already in use. Using the example of a dryer heating boiler which can provide a maximum power of 1200 kW in the case of warm water at 90° C. in the inlet and 60° C. in the outlet, this power increases to 1900 KW if the warm water is at 75° C. in the inlet and 30° C. in the outlet.

According to another aspect of examples disclosed herein, a method for operating a heat supply network is proposed, in particular for a painting plant, comprising a fluid connection for supplying consumers arranged therein with heat and/or cold via a heat transfer fluid in the fluid connection, in which the heat transfer fluid flows fluidically in series through at least two consumers. The first consumer is brought into fluidic connection at least temporarily via the heat transfer fluid, by means of its first outlet for the heat transfer fluid, to the second consumer via the second inlet thereof.

It is advantageously possible to reduce a volume flow of the heat transfer fluid for heating and/or cooling consumers. A lower volume flow allows smaller pipe diameters and/or lower material costs and/or smaller pumps and/or lower electricity costs and/or a smaller space requirement and/or less assembly effort.

With lower temperature requirements, it is possible to open up previously unused waste heat sources within a painting plant.

It is likewise possible to incorporate alternative heat sources, e.g. heat pumps, without necessarily having to use high-temperature heat pumps. It is advantageously possible to use one or more heat pumps in order to connect a heating circuit and a cooling circuit. Considerable energy savings are thus possible, e.g. in a painting plant for painting vehicle bodies.

When using heat pumps, it is possible, in particular, to lower the temperature level of the heat sources.

Moreover, an advantageous reduction in the fossil-based primary energy demand and the associated CO2 emissions is possible.

According to an advantageous embodiment of the method, the heat transfer fluid with the highest temperature level can be fed to the first consumer. The various processes, i.e. consumers, in the process plant, in particular painting plant, are interlinked hydraulically, i.e. fluidically, in such a way that they form a unit. In particular, the first consumer and the at least one second consumer form a temperature cascade as regards the heat transfer fluid. The hot water required for the first consumer is heated only to the temperature level that is required for the process with the highest process temperature. This process is, at the same time, also the first consumer. The subsequent second consumers or process steps receive the outlet of the preceding process step as an inlet. They are operated with warm water, i.e. at a lower temperature than the hot water which is fed to the first consumer. It is possible either for these subsequent consumers to be parallel to one another or for the cascade to be extended, depending on the requirements of the processes.

By means of corresponding sensors and actuators as well as an interface with the heat sources and with the process or consumers, the temperatures in the heat supply can be adapted to the respective operating situation and the heat demand. The consumers can be connected to one another in such a way that the warm water or hot water made available in the inlet is only as hot as necessary, and the temperature in the outlet is correspondingly low.

Ultimately, it is thereby possible to heat the hot water only to the extent necessary for the process with the highest requirements, and the other processes can be operated with warm water.

According to an advantageous embodiment of the method, the heat transfer fluid with the lowest temperature level can be fed to the first consumer. It is not only the supply of heat that can be designed in the above-described manner of a temperature cascade between the first and the at least one second consumer. Cold water networks can likewise be cascaded. In this case, it is possible to supply cold to processes or consumers that can be operated with low cold water temperatures and processes or consumers that can be operated with higher cold water temperatures.

According to an advantageous embodiment of the method, at least one of the consumers and/or at least one of the heat sources can be selectively opened or shut off for the heat transfer fluid. Consumers and heat sources in the process plant can be matched to one another in an advantageous manner that is adapted to current operating parameters.

### BRIEF DESCRIPTION OF THE DRAWINGS

Further advantages will become apparent from the following description of drawings. Exemplary embodiments of examples disclosed herein are illustrated in the figures. The figures, the description and the claims contain numerous features in combination. A person skilled in the art will expediently also consider the features individually and combine them to form useful further combinations.

In the drawings:

FIG. 1 shows an exemplary embodiment of examples disclosed herein with a first and a second consumer;

FIG. 2 shows an exemplary embodiment of examples disclosed herein with a first and a second consumer, each of which can be supplied selectively with a heat source;

FIG. 3 shows an operating state of the arrangement from FIG. 2;

FIG. 4 shows an operating state of the arrangement from FIG. 2;

FIG. 5 shows an operating state of the arrangement from FIG. 2;

FIG. 6 shows an exemplary embodiment of examples disclosed herein with a heat supply network in which consumers are supplied with heat and with cold.

### DETAILED DESCRIPTION OF THE DRAWINGS

In the figures, components of the same kind or with the same action are denoted by the same reference signs. The figures merely show examples and should not be interpreted as restrictive.

Before examples disclosed herein are described in detail, it should be noted that it is not limited to the respective component parts of the apparatus and the respective method steps since these component parts and methods may vary. The terms used here are intended merely to describe particular embodiments and are not used restrictively. Moreover, when the singular or indefinite articles are used in the description or in the claims, this also refers to more than one of these elements, unless the overall context clearly indicates otherwise.

Direction terminology involving terms such as “left”, “right”, “up”, “down”, “in front”, “behind”, “after” and the like is used below merely to facilitate understanding of the figures and is in no way intended to represent a restriction on generality. The illustrated components and elements, their design and their use may vary and may be adapted to the respective applications according to the considerations of a person skilled in the art.

The term “warm water” for water as a heat transfer fluid is used below up to a temperature of 65° C.

Examples disclosed herein are suitable, in particular, for painting plants but also for other plants in which, on the one hand, process heat is required and, on the other hand, various heat sources are available.

In principle, however, examples disclosed herein described above are not limited to a warm water network but can also be extended to a cold water network or even a cooling water network. There are comparable cases here since some processes require a lower temperature level and others require a higher temperature level.

The temperatures mentioned below are temperatures found or necessary in various consumers and/or heat sources in a painting plant.

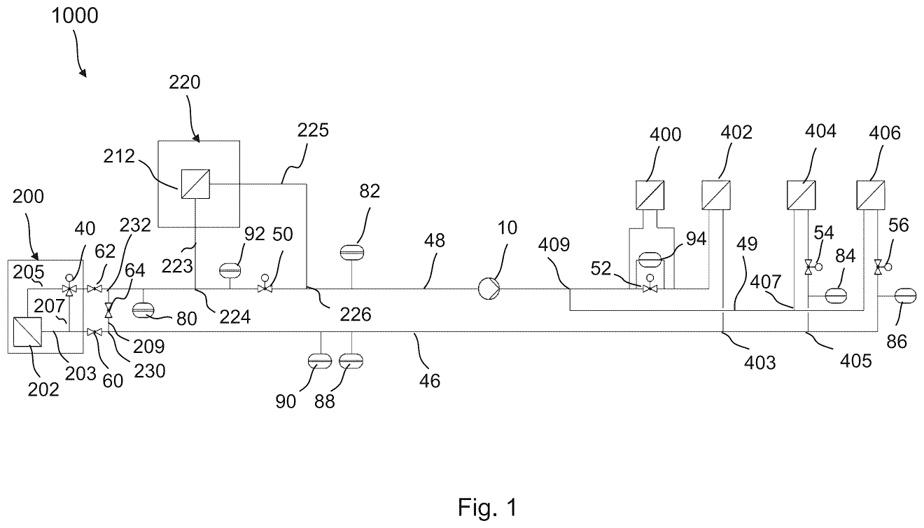

FIG. 1 shows an exemplary embodiment of examples disclosed herein having a first consumer 200 and a second consumer 220 in a heat supply network 1000 for a process plant, in particular for a painting plant.

The heat supply network 1000 has a fluid connection in the form of a heat transfer fluid circuit for supplying consumers 200, 220 arranged therein with heat via a heat transfer fluid in the fluid connection. The heat transfer fluid, in particular water, is circulated between consumers 200, 220 and heat sources 400, 402, 404, 406 by means of a pump 10 in a line 48, for example.

The inlet and outlet of the first consumer 200 for the heat transfer fluid are denoted as the first inlet 203 and the first outlet 205. The inlet and outlet of the second consumer 220 for the heat transfer fluid are denoted as the second inlet 223 and the second outlet 225.

The two consumers 200, 220 are connected hydraulically, i.e. fluidically, in series. In this case, the first consumer 200 is fluidically connected at least temporarily, by means of its first outlet 205 for the heat transfer fluid, to the second consumer 220 via the second inlet 223 thereof.

The first consumer 200 is symbolized by a heat exchanger 202, to which the first inlet 203 and the first outlet 205 are connected. For example, the first consumer 200 is an apparatus for the pretreatment and cathodic dip coating VBH/KTL of vehicle bodies in a painting plant.

Via a line 46, the first inlet 203 of the first consumer 200 receives heat transfer fluid at a high temperature level, e.g. 75° C., from one or more of the heat sources 400, 402, 404, 406. Heat sources 402, 404 and 406 are connected fluidically in parallel with both consumers 200, 220, which are arranged in series with one another. Heat source 400 is connected in series with heat source 402. In line 46, the temperature and pressure of the heat transfer fluid are detected by a temperature sensor 88 and a pressure sensor 90. It is likewise possible to provide one or more pressure sensors (not illustrated).

The first consumer 200 and the second consumer 220 are arranged in a cascaded manner in respect of the heat transfer fluid. The first consumer 200 receives the heat transfer fluid at the highest temperature level, while the following second consumer 220 receives the heat transfer fluid at a lower temperature level. The hot water required for the first consumer 200 is heated only to the temperature level that is required for the process with the highest process temperature that is taking place there. This process is also simultaneously referred to as the first consumer 200. The second consumer 220 or process step following fluidically in series therewith receives heat transfer fluid from the outlet 205 of the preceding process step as an inlet 223 at a correspondingly lower temperature level.

The temperature of the heat transfer fluid in the first outlet 205 of the first consumer 200 is detected by means of a temperature sensor 80. When the first consumer 200 is in operation, the temperature sensor 80 indicates whether the outlet temperature of the heat transfer fluid from the first consumer 200 corresponds to the medium temperature required by the second consumer 220. The outlet temperature is raised if this is not the case. For this purpose, a three-way valve 40 of the first consumer 200 can add the warmer heat transfer fluid from the first inlet 203 to the cooler heat transfer fluid in the first outlet 205 via a connecting line 207.

When the first consumer 200 is not in operation, the first inlet 203 and/or the first outlet 205 can be shut off by means of shutoff valves 60, 62, and heat transfer fluid can be passed between the first inlet 203 and the first outlet 205 via a bypass line 209 by opening a shutoff valve 64 in the bypass line 209. The bypass line 209 is connected to line 46 at branch 230 and to line 48 at branch 232.

The second consumer 220, symbolized by a heat exchanger 212, is connected by its second inlet 223 to the first outlet 205 of the first consumer 200. The second consumer 220 can be, for example, an air supply which requires a medium temperature level of the heat transfer fluid, e.g. 65° C. Heat transfer fluid at this medium temperature level is received by the second consumer 220 from the first outlet 205 of the first consumer 200 at the second inlet 223 via line 48.

The heat transfer fluid at the second outlet 225 is at a low temperature, e.g. 30° C.

The second inlet 223 branches off from line 48 at a branch 224, and the second outlet 225 opens into line 48 at branch 226. Arranged in the relevant section of line 48, between the two branches 224, 226, is a pressure sensor 92, and downstream of this is a control valve 50. If the latter is closed, the heat transfer fluid flows through the second inlet 223 and outlet 225 of the second consumer 220. The pressure sensor 92 indicates the heat consumption of the second consumer 220.

Arranged downstream of branch 226 and upstream of the pump 10 is another temperature sensor 82, which detects the temperature downstream of the second outlet 225 of the second consumer 220.

At branch 409, a line 49 leads to heat sources 404, 406. Heat source 404 is connected in parallel with heat source 406 via the branches 407 and 405 between lines 49 and 46.

Respective temperature sensors 84, 86 and control valves 54, 56 are arranged at the outlets of the two heat sources 404, 406. This enables the outlet temperature of heat sources 404, 406 to be detected individually and enables heat sources 404, 406 to be shut off or connected up individually.

Together, heat sources 400 and 402 form a series circuit which is parallel to the two heat sources 404, 406. A pressure sensor 94 and, in parallel with the latter, a control valve 52, are arranged between the inlet and the outlet of heat source 400, in the corresponding section of line 48. If said valve is closed, the heat transfer fluid flows through the inlet and the outlet of heat source 400 and onward through the inlet and the outlet of heat source 402.

When the first consumer 200 is in operation, heat transfer fluid with the high temperature level, e.g. 75° C., is present in line 46. When the first consumer 200 is not in operation, the temperature level is adjusted to the demand of the second consumer 220 under the control/monitoring of sensor 80, e.g. to 65° C.

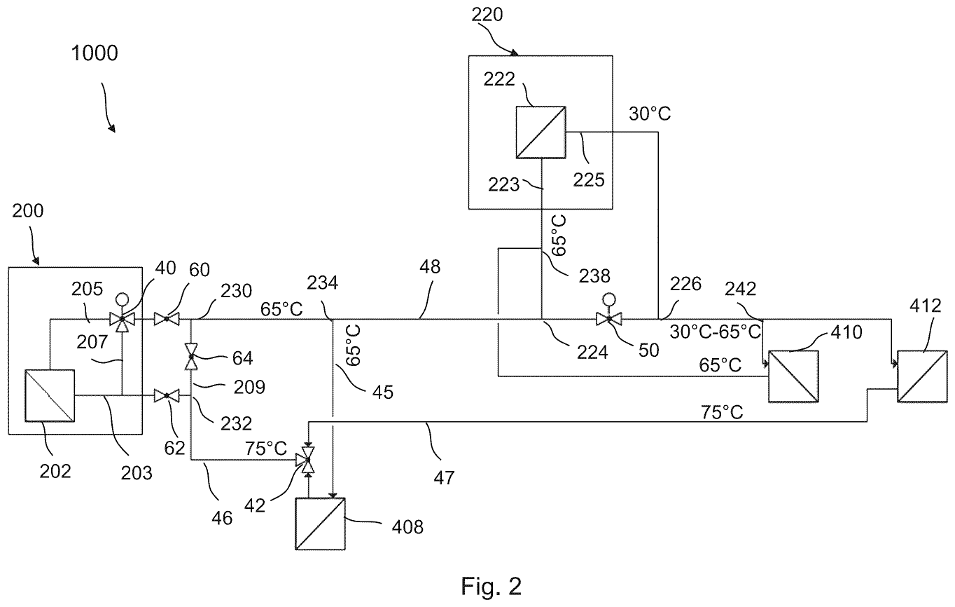

FIG. 2 shows an exemplary embodiment of examples disclosed herein having a first consumer 200 and a second consumer 220 in a heat supply network 1000 for a process plant, in particular for a painting plant, each of which consumers can be supplied selectively by a heat source 408, 410, 412.

As illustrated by way of example in FIG. 1, the first consumer 200 can be an apparatus for the pretreatment and cathodic dip coating VBH/KTL of vehicle bodies in a painting plant. The second consumer 220 can be an air conditioning system (HVAC), for example. Sensors and pumps are not shown explicitly but may be present as in FIG. 1. The fluidic series connection of the first consumer 200 to the second consumer 220 as a cascade, and the connection of consumers 200, 220 to lines 46 and 48 with a three-way valve 40, shutoff valves 60, 62, a bypass line 209 with a shutoff valve 64 and a control valve 50 between the second inlet 223 and the second outlet 225 of the second consumer 220 corresponds to the description of FIG. 1, to which reference is made for the avoidance of unnecessary repetitions.

As a departure from the exemplary embodiment in FIG. 1, a heat source 408, 410 is connected in parallel with each consumer 200, 220. The heat source 408 for supplying the first consumer 200 with heat transfer fluid is connected in parallel with the first consumer 200, and the heat source 410 for supplying the second consumer 220 with heat transfer fluid is connected in parallel with the second consumer 220.

A heat source 412 is connected fluidically in parallel with the series circuit comprising the first consumer 200 and the second consumer 220.

The outlet (not denoted specifically) of heat source 412 is connected to the inlet 203 of the first consumer 200 via line 47, which merges into line 46. The inlet (not denoted specifically) of heat source 412 is selectively connected to the outlet 205 of the first consumer 200 and the outlet 225 of the second consumer 220.

Heat source 408 is connected to the first outlet 205 of the first consumer 200 via a line 45, which starts from a branch 234 from line 48 and leads to the inlet of heat source 408.

A three-way valve 42 is arranged at the outlet of heat source 408. Three-way valve 42 forms the transition between line 47 and line 46. Line 47 and the outlet of heat source 408 open into three-way valve 42. From the outlet of three-way valve 42, line 46 branches off to the first inlet 203 of the first consumer 200. The inlet of heat source 408 is connected to line 48, and the outlet is connected to the inlet 203 of the first consumer 200.

The second consumer 220 is supplied by heat source 410. The outlet of said heat source is connected at branch 238 to the second inlet 223 of the second consumer 220, and, downstream of branch 226, at which the second outlet 225 opens into line 48, the inlet of said heat source is connected at branch 242 to line 48.

The outlet of heat source 412 is connected via line 47 to the first inlet 203 of the first consumer 200 or of the three-way valve 42 of heat source 408. The inlet of heat source 412 is selectively connected to the outlet 205 of the first consumer 200 or the outlet 225 of the second consumer 220.

Temperatures that the heat transfer fluid can assume in lines 46, 47, 48, 49 and other lines not denoted specifically are indicated by way of example for illustration.

In line 45, the heat transfer fluid can be at 65° C. In lines 46, the heat transfer fluid can be at 75° C. In line 47, the heat transfer fluid can be at 75° C. In line 48, the heat transfer fluid can be at 65° C. In the line at the inlet 223 of the second consumer 220, the heat transfer fluid can be at 65° C., and, at the outlet 225, the heat transfer fluid can be at 30° C. At the inlet of heat source 412, the heat transfer fluid can have a temperature of between 30° C. and 65° C.

When the first consumer 200 is not in operation, the temperature in line 46 is dependent on whether the heat is generated by 410 or 412, in accordance with the requirements of the second consumer 220. If the heat is generated by 412, the temperature in line 46 is in accordance with the requirements of the second consumer 220, that is to say, for example, 65° C. If the heat is generated by 410, there is no flow through line 46.

The first consumer 200 requires 75° C. in the inlet of heat exchanger 202 and is at 65° C. in the outlet. The second consumer 220 requires 65° C. in the inlet of the second heat exchanger 222 and is at 30° C. in the outlet. Heat source 408 can provide heat transfer fluid, in particular water, at 75° C., and requires 65° C. in the inlet (temperature in “45”). Heat source 410 can provide heat transfer fluid at 65° C., and, for example, requires heat transfer fluid at 65° C. to 30° C. in the inlet (temperature at “242”). Heat source 412 can provide heat transfer fluid at 75° C., and requires 65° C. to 30° C. in the inlet (temperature at “242”).

If the first consumer 200 requires heat, this can be provided by heat source 408 and/or 412.

If the second consumer 220 requires heat, this can be provided by heat source 410 and/or 412.

If both consumers 200 and 220 require heat, this can be provided by heat source 408 and/or 410 and/or 412, depending on the availability of waste heat, for example, or not, as the case may be.

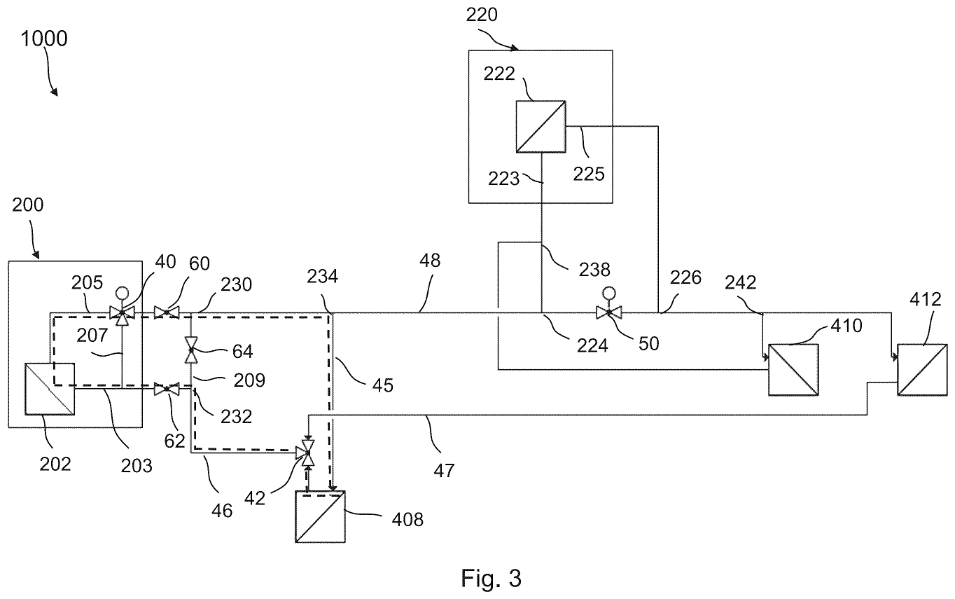

FIGS. 3, 4 and 5 show various operating states of the arrangement shown in FIG. 2. The respective circuits of the heat transfer fluid are indicated by dashed lines.

In FIG. 3, heat source 408 supplies the heat exchanger 202 of the first consumer 200, for example. Heat transfer fluid flows via line 46 from heat source 408 to the inlet 203 of the first consumer 200 and back to heat source 408 from the outlet 205 via line 45. All other lines are shut off.

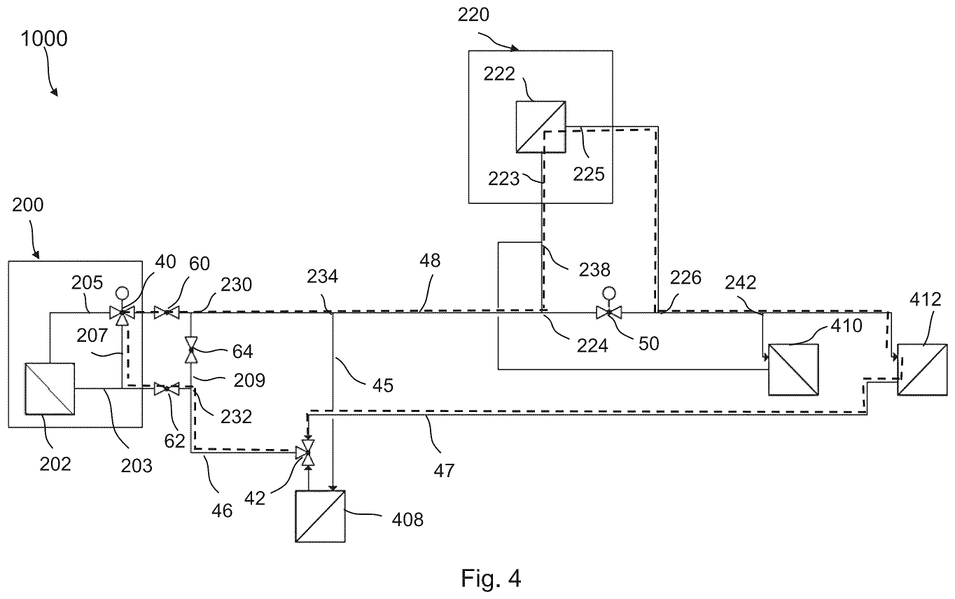

In FIG. 4, heat source 412 supplies the heat exchanger 222 of the second consumer 220, for example. Heat transfer fluid flows via line 47 and three-way valve 42, the bypass 207 of the first consumer 200, and line 48 from heat source 412 to the inlet 223 of the second consumer 220 and, from the outlet 225 of the latter, back to heat source 412. All other lines are shut off.

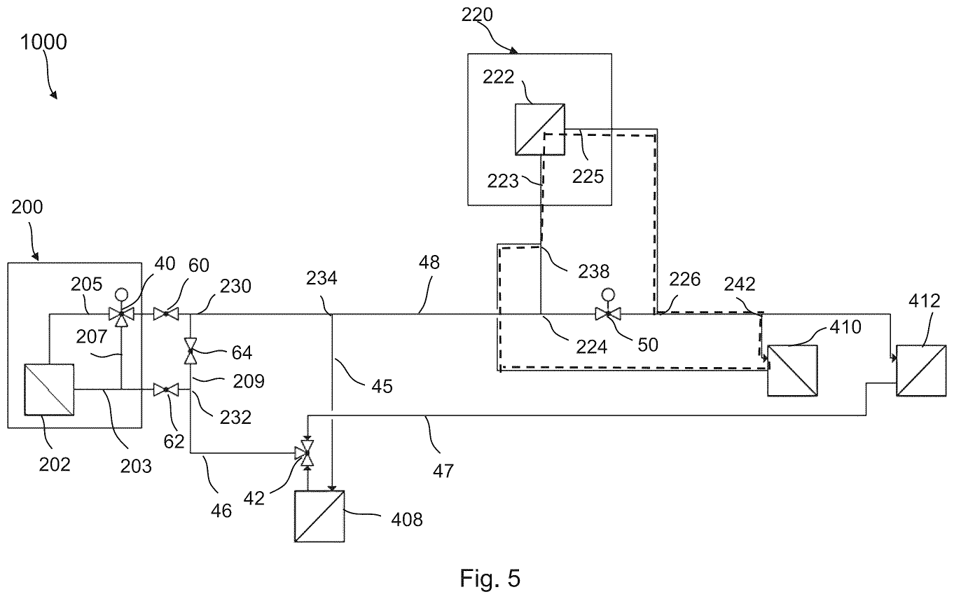

In FIG. 5, heat source 410 supplies the heat exchanger 222 of the second consumer 220, for example. Heat transfer fluid flows from the outlet of heat source 410 to the inlet 223 of the second consumer 220 and back to heat source 410 via the outlet 225. All other lines are shut off.

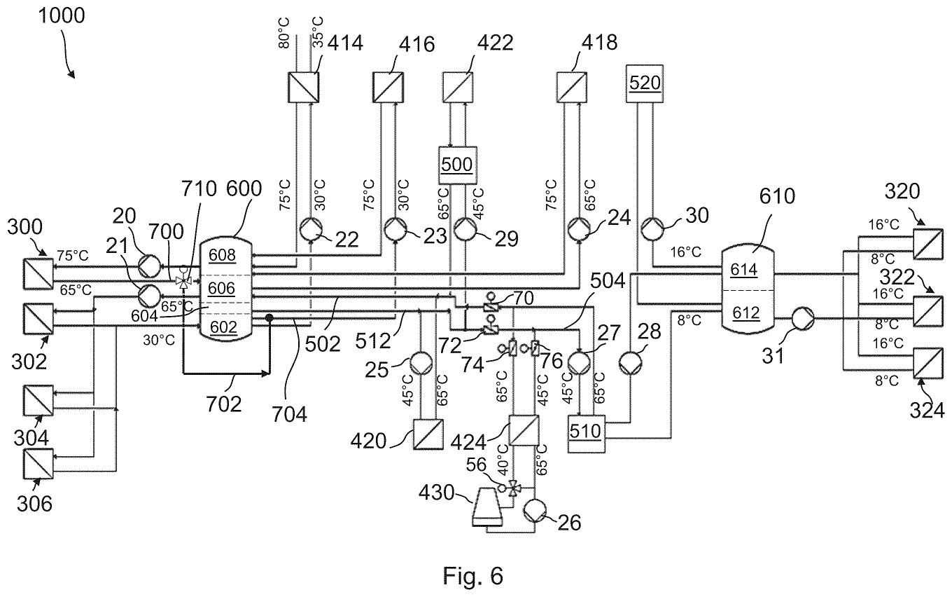

FIG. 6 presents an exemplary embodiment of examples disclosed herein having a heat supply network 1000 in which consumers 300, 302, 304, 306 are supplied with heat and consumers 320, 322, 324 are supplied with cold. The heat supply and the cold supply are coupled by heat pumps 500, 510 and a cold generator 520.

The inlet and outlet of the consumers 300, 302, 304, 306, 320, 322, 324 are not designated separately but can be distinguished from the directions of the arrows in the figure. Here, consumer 300 forms the first consumer 300, which is supplied with a heated heat transfer fluid, e.g. water, at the highest temperature level in the heat supply network 1000. Consumers 320, 322, 324 form first consumers, which are supplied with cooled heat transfer fluid at the lowest temperature level in the heat supply network 1000.

As in FIG. 1, there can be temperature sensors and pressure sensors, flow sensors and the like, but these are not illustrated here.

On the side of the supply with heated heat transfer fluid, second consumers 302, 304, 306 are arranged downstream. The second consumers 302, 304, 306 are connected fluidically in parallel. The heat transfer fluid is moved by a pump 20 in the inlet of the first consumer 300 and by a pump 21 in the inlet of the second consumer 302. A hydraulic separator 600 in the form of a multivalent reservoir is arranged between the first consumer 300 and the second consumers 302, 304, 306.

The hydraulic separator 600 is likewise arranged between consumers 300, 302, 304, 306 and components 414, 416, 418, 420, 422, 424 corresponding to heat sources 414, 416, 418, 420, 422 and heat exchanger 424, as well as heat pumps 500, 510 and a cold generator 520. The hydraulic separator 600 is used to distribute the heated heat transfer fluid in the region of consumers 300, 302, 304, 306. Another hydraulic separator 610 is used to supply consumers 320, 322, 324 with cooled heat transfer fluid.

In this case, heat pump 500 is connected to hydraulic separator 600, while heat pump 510 is connected on one side to hydraulic separator 600 and on the other side to hydraulic separator 610. The cold generator 520 is connected only to hydraulic separator 610.

Both hydraulic separator 600 and hydraulic separator 610 enable various heat sources 414, 416, 418, 420, 422 at different temperature levels to be brought together at a single point with a large number of consumers 300, 302, 304, 306 and 320, 322, 324, respectively, at different temperature levels.

The two hydraulic separators 600, 610 are coupled via heat exchanger 424 and heat pump 510.

In summer operation, that is to say when the heat demand of the paint shop is low but the cold demand is very high, heat pump 510 is used exclusively for cold generation. The heat which arises in heat pump 510 during this process cannot be used by the paint shop and must be discharged to the environment via the cooling tower 430 since otherwise it is not possible to generate cold.

In order to cope with all operating conditions, the cooling circuit between heat exchanger 424 and the cooling tower 430 contains heat transfer fluid, in particular water, with a proportion of antifreeze. In winter, the cooling tower 430 is typically out of operation, but the heat transfer fluid must not freeze. When heat pump 510 is in pure cooling operation in the summer, it is separated from the heat network by means of butterfly valves 70 and 72, and the heat transfer fluid is sent to the cooling tower 430 via butterfly valves 74 and 76, which are then open, and via heat exchanger 424.

By way of example, the first consumer 300 represents a high-temperature process, as before, for example, for pretreatment and cathodic dip coating VBH/KTL. Second consumer 302 represents a building air conditioning system in the painting plant. By way of example, second consumer 304 represents a process that requires air conditioning. Second consumer 306 represents another process, which likewise requires such a temperature level.

Hydraulic separator 600 has a temperature stratification, which is indicated by broken lines. In the exemplary embodiment illustrated, there are four regions 602, 604, 606, 608. From bottom to top in the figure, the lowest temperature level, e.g. 30° C., is present in the lowest region 602 of hydraulic separator 600, followed by region 604 with a somewhat higher intermediate temperature level, e.g. 45° C., followed by region 606 with a medium temperature level, e.g. 65° C. and, above that, the uppermost region 608 with the highest temperature level, e.g. 75° C.

The temperatures and distribution of the temperature regions in hydraulic separator 600 should be taken as illustrative and may differ in other applications. In this exemplary embodiment, they describe advantageous temperatures for conventional processes in a painting plant.

By way of example, the heat sources 414, 416, 418, 420, 422, 424 are waste heat sources, which were not used hitherto to control the temperature of a heat transfer fluid in painting plants.

To circulate the heat transfer fluid, each of the heat sources 414, 416, 418, 420 is assigned a pump 22, 23, 24, 25 in the respective inlet. A pump 26 is arranged downstream of heat source 424, between the latter and the cooling tower 430.

The inlet of the first consumer 300 is connected in region 608 to the highest temperature level and accordingly receives heat transfer fluid at 75° C. The outlet of the first consumer 300 is connected in region 606 to the medium level and feeds in heat transfer fluid there at 65° C. into region 606 via line 700. The inlet of the second consumers 302, 304, 306 is connected to this region 606, said consumers being supplied at 65° C. in the inlet. Heat transfer fluid is fed from the outlet of the second consumers 302, 304, 306 into the lowest region 602 at 30° C.

Heat source 414 is a representative example of the waste heat from one or more compressors and delivers heat transfer fluid at 75° C. to the region 608 of hydraulic separator 600 with the highest temperature level. Conversely, hydraulic separator 600 delivers cooled heat transfer fluid from the region 602 with the lowest temperature level of 30° C. to heat source 414.

Heat source 416 is a representative example of the waste heat from one or more ovens and delivers heat transfer fluid at 75° C. to the region 608 of hydraulic separator 600 with the highest temperature level. Conversely, hydraulic separator 600 delivers cooled heat transfer fluid from the region 602 with the lowest temperature level of 30° C. to heat source 416 via line 704.

Heat source 418 is a representative example of the waste heat from a heating boiler and delivers heat transfer fluid with the highest temperature level of 75° C. to region 608 of hydraulic separator 600 and receives heat transfer fluid from the region 606 with a medium temperature level of 65° C.

An overflow line 702 connects the line 700 leading to region 606 of separator 600 and the line 704 leading from region 602 to heat source 416, and thus connects an inlet and an outlet of regions of the hydraulic separator 600 with different temperatures. The overflow line 702 is connected to line 700 by the controllable three-way valve 710. The overflow line 702 ensures operation in all operating states, e.g. when starting up the heat supply network 1000.

If, for example, a heat output is required of separator 600 at temperature levels of 75°/65° and 65°/30°, the correspondingly temperature-controlled heat transfer fluid, in particular warm water, can be provided by heat source 416 and heat source 418, for example.

If, however, the volume-flow-based decrease in consumer or consumers 300 is greater than the volume-flow-based decrease in consumers 302, 304 and 306, the temperature level in region 602 of separator 600, with a target temperature of 30° C. on the return, would be raised by the consumer or consumers 300. Heat sources 414, 422, 510 would thus also receive a higher inlet temperature, and the amount of heat that could be fed into the system would fall. This can advantageously be avoided by means of the overflow line 702 since the “excess” volume flow can be passed directly from consumer or consumers 300 to heat source 416 by switching the three-way valve 710 in a correspondingly operation-dependent manner.

This is particularly advantageous if, for example, heat source 416 comprises one or more components that can be operated optionally at 75°/30° or 65°/30°.

Heat source 420 is a representative example of the waste heat from a boiler for air conditioning (HVAC) and delivers heat transfer fluid to region 606 of hydraulic separator 600 with a temperature level of 65° C. and receives heat transfer fluid from region 604 of said separator with a temperature level of 45° C. Here, heat source 420 is connected to hydraulic separator 600 at two lines 502 and 512, of which line 502 leads to region 606 and line 512 leads away from region 604.

Heat pump 500 supplies heat source 422 with waste heat. Heat source 422 is, for example, the waste heat from the cooling zone, i.e. a relatively large quantity of air with temperatures of about 20° C. to 30° C. or even somewhat higher is available, depending on the specific process. Although the energy cannot be used directly, it can be rendered usable by heat pump 500.

On one side, it is then possible, for example, to produce warm water and make it available to the process via hydraulic separator 600. However, the exhaust air from the cooling zone, for example, is “warm” enough to heat the cold water that has been formed from, for example, 10° C. to 16° C. on the cold side of heat pump 500, thus enabling heat pump 500 to function.

Heat pump 500 can have a power of 140 KW, for example. The heat transfer fluid is fed by a pump 29 to the inlet of heat pump 500. Heat pump 500 delivers heat transfer fluid at a temperature level of 75° C., with an inlet temperature of the heat transfer fluid of 65° C., via a line 504 to another heat pump 510.

Line 512 opens into line 504. Lines 502 and 504 have butterfly valves 70 and 72, respectively, which open or shut off the lines as required.

The outlet of heat pump 500, at 65° C., is fed to region 606 with heat transfer fluid. The inlet of heat pump 500 receives heat transfer fluid from region 605 of hydraulic separator 600 at, for example, 45° C.

The second heat pump 510 primarily generates required process cold, and the waste heat is correspondingly incorporated into the heat supply for consumers 300, 302, 304, 306. At the same time, heat pump 510 can be regarded as a cold generator and can be regarded as a combination with other cold machines 520.

Heat source 424 is a representative example of the waste heat from a process involving the cooling tower 430, which is preferably used in summer at high ambient temperatures. On its primary side, heat source 424 receives heat transfer fluid at 65° C. in the inlet from the outlet on the primary side of heat pump 510 and delivers heat transfer fluid at 45° C. to the inlet of heat pump 510. The inlet and outlet can each be opened or shut off by means of a respective throttle valve 74, 76.

The cooling tower 430 receives heat transfer fluid from the secondary side of heat source 424 at 65° C. and delivers heat transfer fluid at 40° C. to heat source 424. In this case, the heat transfer fluid with the two different temperature levels can be mixed by means of a three-way valve 56 between the cooling tower 430 and heat source 424. A pump 26 drives the circulation of the heat transfer fluid between heat source 424 and the cooling tower 430.

Heat pump 510 furthermore delivers heat transfer fluid at 65° C. to region 606 of hydraulic separator 600 via line 502 and receives heat transfer fluid at 45° C. from region 604.

Connected to the secondary side of heat pump 510 is hydraulic separator 610, which is used to supply consumers 320, 322, 324 with cooled heat transfer fluid, wherein the outlet of heat pump 510 is connected to a region 612 containing heat transfer fluid at, for example, 8° C., and the inlet is connected to a region 614 containing heat transfer fluid at, for example, 16° C. The heat transfer fluid is circulated between hydraulic separator 610 and the secondary side of heat pump 510 by means of a pump 28 in the inlet of heat pump 510. A cold generator 520 is likewise connected to the first region 612 and the second region 614. A pump 30 circulates the heat transfer fluid between hydraulic separator 610 and cold generator 520.

By means of pump 31, hydraulic separator 610 delivers cold heat transfer fluid at, for example, 8° C. from region 612 to the respective inlet of consumers 320, 322, 324. From the outlet thereof, heat transfer fluid at 16° C. is returned to region 614 of hydraulic separator 610.

Consumers 320, 322, 324 are used to cool processes in the process plant. Thus, consumer 320 serves, by way of example, to cool a pretreatment and cathodic dip coating process. By means of waste heat from pumps and heat generation during the energization of electrodes in treatment baths, it is thereby possible to limit heating up of the treatment baths.

Consumer 320 can be used, for example, for cooling in the air conditioning of the building.

Consumer 322 can serve, by way of example, to cool processes which require air conditioning.

In an optional exemplary embodiment that is not illustrated, consumers 320, 322, 324 can also be used in a series circuit as a cascade, like consumers 300, 302, 304, 306, wherein the first consumer receives the heat transfer fluid at the lowest temperature level, and the second consumer or consumers receives or receive at the inlet correspondingly warmer heat transfer fluid from the outlet of the first consumer.

By coupling heat generation and cold generation in the heat supply network 1000, it is possible to achieve considerable energy savings. Thus, in an illustrative painting plant, it is possible to save about 20% of the energy required for heating and cooling, about 6 MWh/a. The savings may fluctuate, depending on the plant, and are dependent on the location and the project-specific requirements of the process.

### REFERENCE SIGNS

10 pump
20 pump
21 pump
22 pump
23 pump
24 pump
25 pump
26 pump
27 pump
28 pump
29 pump
30 pump
31 pump
40 three-way valve
42 three-way valve
45 line
46 line
47 line
48 line
49 line
50 control valve
52 control valve
54 control valve
56 three-way valve
58 control valve
60 shutoff valve
62 shutoff valve
64 shutoff valve
70 butterfly valve
72 butterfly valve
74 butterfly valve
76 butterfly valve
80 sensor
82 sensor
84 sensor
86 sensor
88 sensor
90 sensor
92 sensor
94 sensor
200 consumer
203 inlet
205 outlet
207 bypass
209 bypass
212 heat exchanger
220 consumer
222 heat exchanger
223 inlet
224 branch
225 outlet
226 branch
227 bypass
230 branch
232 branch
234 branch
238 branch
242 branch
300 consumer
302 consumer
304 consumer
306 consumer
320 consumer
322 consumer
324 consumer
400 heat source
402 heat source
403 branch
404 heat source
405 branch
406 heat source
407 branch
408 heat source
409 branch
410 heat source
412 heat source
414 heat source
416 heat source
418 heat source
420 heat source
422 heat source
424 heat exchanger
430 cooling tower
500 heat pump
502 line
520 cold generator
510 heat pump
600 separator
602 region
604 region
606 region
608 region
610 separator
612 region
614 region
700 line
702 overflow line
704 line
710 three-way valve
1000 heat supply network

1. A thermal supply network for a process plant, in particular for a painting plant, the supply network comprising:
a fluid connection for supplying consumers arranged therein with heat and/or cold via a heat transfer fluid in the fluid connection, in which at least two consumers are connected fluidically in series,
wherein the first consumer is fluidically connected at least temporarily, by its first outlet for the heat transfer fluid, to a second consumer via the second inlet thereof.

2. The supply network as claimed defined in claim 1, wherein, to supply heat, at least one thermal source having the highest temperature of the heat transfer fluid is connected to the first inlet of the first consumer.

3. The supply network as defined in claim 1, wherein, to supply cold cooling, at least one thermal source having the lowest temperature of the heat transfer fluid is connected to the first inlet of the first consumer.

4. The supply network as defined in claim 1, wherein, downstream of the first consumer in respect of the heat transfer fluid, a plurality of second consumers is connected fluidically in series and/or in parallel.

5. The supply network as defined in claim 1, wherein at least one temperature sensor is arranged in a section of the fluid connection between the first outlet of the first consumer and the second consumer.

6. The supply network as defined in claim 1, wherein a pressure sensor is arranged in a section of the fluid connection between the first outlet of the first consumer and the second consumer.

7. The supply network as defined in claim 1, wherein a bypass line for bypassing the first and/or the at least one second consumer is arranged in the fluid connection.

8. The supply network as defined in claim 1, wherein at least one control valve, which selectively opens or shuts off at least one of the consumers and/or at least one of the heat sources for the heat transfer fluid, is arranged in the fluid connection.

9. The supply network as defined in claim 1, wherein a plurality of heat sources and/or cold sources is arranged fluidically in series and/or in parallel in respect of the heat transfer fluid.

10. The supply network as claimed defined in claim 1, wherein at least one heat source is arranged fluidically in parallel with the at least one second consumer.

11. The supply network as defined in claim 1, wherein at least one heat source has, at its respective outlet, a three-way valve, the inlet of which is connected to at least one further heat source and the outlet of which is connected to the inlet of the first consumer.

12. The supply network as defined in claim 1, wherein the first consumer and the at least one second consumer are fluidically connected, by means of a respective inlet and a respective outlet, via at least one hydraulic separator, wherein the at least one hydraulic separator has at least two temperature zones with different temperature levels.

13. The supply network as defined in claim 12, wherein there is a fluidic connection from the at least one hydraulic separator to the consumers and to the heat sources.

14. The supply network as defined in claim 12, wherein an inlet and an outlet for heat transfer fluid of the at least one hydraulic separator are connected by an overflow line, in particular an inlet to a region of the separator with a higher temperature of the heat transfer fluid being connected to an outlet from a region of the separator with a lower temperature of the heat transfer fluid.

15. The supply network as defined in claim 1, wherein at least one heat pump and/or one cold generator are/is arranged in the fluid connection.

16. The supply network as defined in claim 1, wherein at least one of the heat sources is a waste heat source.

17. A method for operating a thermal supply network for a process plant as defined in claim 1, in particular for a painting plant, the method comprising:
supplying, with a fluid connection, consumers arranged therein with heating and/or cooling via a heat transfer fluid in the fluid connection, in which the heat transfer fluid flows fluidically in series through at least two consumers,
wherein the first consumer is brought into fluidic connection at least temporarily via the heat transfer fluid, by of its first outlet for the heat transfer fluid, to the second consumer via the second inlet thereof.

18. The method as defined in claim 17, wherein the heat transfer fluid with the highest temperature level is fed to the first consumer.

19. The method as defined in claim 17, wherein the heat transfer fluid with the lowest temperature level is fed to the first consumer.

20. The method as defined in claim 17, wherein at least one of the consumers and/or at least one of the heat sources is selectively opened or shut off for the heat transfer fluid.
